(19) United States
(12) Patent Application Publication
(10) Pub. No.: US 2009/0001758 A1
(43) Pub. Date: Jan. 1, 2009

(54) EXPANDABLE INSERT FOR HOLLOW STRUCTURE

(75) Inventors: John L. Hanley, IV, Sterling Heights, MI (US); Patricia Heidtman, Livonia, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Sika Technology AG

(21) Appl. No.: 11/771,288

(22) Filed: Jun. 29, 2007

(51) Int. Cl. B62D 25/00

(52) U.S. Cl. 296/187.02

(57) ABSTRACT

An expandable insert and a method of making the same are disclosed. An expandable insert may generally include an expandable body that extends along a hollow structure, and has a continuous outer periphery. A passageway extends through the outer periphery that allows fluid communication therethrough. The expandable insert is operable to be expanded to fill a cross-section of the hollow structure. A method of forming an expandable insert may generally include forming an expandable body, including forming a continuous outer periphery and a passageway extending through the outer periphery to allow fluid communication therethrough. The method may further include expanding the elongated body to fill a cross-section of the hollow structure.

### BACKGROUND

Expandable materials are commonly employed for improving acoustic or structural qualities of automobiles. Typically, an expandable material is placed within a cavity of a vehicle body, and expanded, such as by applying heat, during the vehicle manufacturing process to fill a portion of the cavity. Expandable materials may become a foam material effective for absorbing vibration or abating noise transmitted through the body structure. Other expandable materials may become extremely stiff after expansion to increase the overall stiffness or strength of the body structure.

Expandable materials are typically formed on the outer surface of a carrier element to form a carrier assembly. The carrier assembly may be installed within a vehicle cavity by mechanically attaching the carrier to an inner surface of the cavity. Alternatively, the expandable material may be provided with an adhesive or otherwise “tacky” outer surface that generally secures the assembly to an inner surface of the cavity. The expandable material may then expanded to generally fill the volume between the carrier element and the inner surface of the cavity, thereby supporting the carrier within the cavity. Carrier elements themselves may be formed of a stiff material, e.g., steel, that provides further structural support to a vehicle cavity.

Carrier elements may also increase assembly costs and add complexity to the vehicle and manufacturing process. For example, carrier elements increase the number of parts in a vehicle and may be relatively heavy, especially where the carrier element is formed of a metallic material. Additionally, carrier elements may be difficult to properly secure within a vehicle cavity.

Carrier assemblies may also generally inhibit drainage of fluids applied to a vehicle body during the production process, e.g., electrocoating fluids. Typically, vehicle body structures are subjected to a liquid coating process, e.g., electrocoating, during the assembly process to improve corrosion resistance of the body. Liquid coating processes may reduce the ability of some adhesives to bond the carrier assembly to the surface and, as such, carrier assemblies are preferably installed prior to the liquid coating process to allow any adhesives used to install the carrier assembly to properly adhere to the untreated surface of the vehicle body. Unfortunately, carrier assemblies installed prior to the liquid coating process may inhibit drainage of fluid out of the cavity. Further, where a drainage passageway is provided in the carrier element to allow drainage, expandable materials applied to the carrier element will generally be prevented from entirely filling the cross-section of a vehicle cavity, limiting the capability of the expanded material to properly attenuate noise and vibration transmitted through the cavity.

Accordingly, there is a need in the art for an expandable material design that simplifies installation and allows improved drainage of a vehicle cavity, while also providing adequate vibration and noise attenuation qualities and/or structural rigidity to the vehicle cavity.

### SUMMARY

According to various exemplary illustrations described herein, an expandable insert, method of making the same, and a vehicle structure are provided. An expandable insert generally includes an expandable body that extends along a hollow structure. The expandable body includes a continuous outer periphery and a passageway extending through the outer periphery to allow fluid communication through the passageway. The expandable baffle is operable to be expanded to fill a cross-section of the hollow structure.

A method of forming an expandable insert generally includes forming an expandable body that extends along a hollow structure, including forming a continuous outer periphery, and forming a passageway extending through the outer periphery to allow fluid communication therethrough. The method further includes expanding the expandable body to fill a cross-section of the hollow structure.

### BRIEF DESCRIPTION OF THE DRAWINGS

While the claims are not limited to the illustrated examples, an appreciation of various aspects is best gained through a discussion of various examples thereof. Referring now to the drawings, a variety of examples are shown in detail. Although the drawings represent the various illustrations, the drawings are not necessarily to scale and certain features may be exaggerated to better illustrate and explain an innovative aspect of an example. Further, the examples described herein are not intended to be exhaustive or otherwise limiting or restricting to the precise form and configuration shown in the drawings and disclosed in the following detailed description. Exemplary illustrations of the present invention are described in detail by referring to the drawings as follows.

FIG. 1 is an isometric view of a hollow body cavity including an expandable insert prior to expansion;

FIG. 2 is an isometric view of a hollow body cavity including an expandable insert after expansion;

FIG. 3A is a cross-sectional view of a hollow body cavity including an expandable insert defining a generally circular cross-section prior to assembly of the hollow body cavity;

FIG. 3B is a cross-sectional view of a hollow body cavity including an expandable insert defining a generally circular cross-section after assembly of the hollow body cavity;

FIG. 4A is a cross-sectional view of a hollow body cavity including an expandable insert defining a generally star-shaped cross-section prior to assembly of the hollow body cavity;

FIG. 4B is a cross-sectional view of a hollow body cavity including an expandable insert defining a generally star-shaped cross-section after assembly of the hollow body cavity;

FIG. 4C is a cross-sectional view of an expandable insert defining a generally circular cross-section having square-shaped extensions;

FIG. 4D is a cross-sectional view of an expandable insert defining a generally circular cross-section having hook-shaped extensions;

FIG. 5A is a cross-sectional view of a hollow body cavity having an irregular cross-sectional shape, and an expandable insert defining a generally circular cross-section prior to assembly of the hollow body cavity;

FIG. 5B is a cross-sectional view of a hollow body cavity having an irregular cross-sectional shape, and an expandable insert defining a generally circular cross-section after assembly of the hollow body cavity;

FIG. 6A is a cross-sectional view of a hollow body cavity including an expandable insert secured to the cavity with a mechanical fastener prior to assembly of the hollow body cavity;

FIG. 6B is a cross-sectional view of a hollow body cavity including an expandable insert secured to the cavity with a mechanical fastener after assembly of the hollow body cavity;

FIG. 7 is a partial section view of a vehicle D-pillar cavity including an expandable insert arranged in a folded configuration within the cavity; and

FIG. 8 is an exemplary process flow diagram for manufacturing an expandable insert.

### DETAILED DESCRIPTION

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

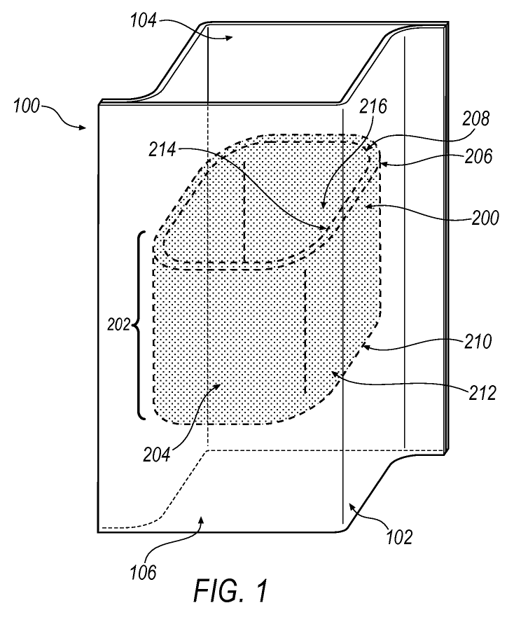

Turning now to FIG. 1, a hollow structure 100 and an expandable insert 200 are illustrated. Hollow structure 100 may be formed of one or more panels, e.g., body panels, that are joined by any known mechanical process. For example, as shown in FIG. 1, hollow structure 100 may be formed of a first panel 102 which is welded to a second panel 104. One or more flanges may be formed on either of first and second panels 102, 104, for welding first and second panels 102, 104 together. Any other type of hollow structure 100 may be used with expandable insert 200. Accordingly, hollow structure 100 may be formed with any number of panels, and may even be formed with a single panel or structure that surrounds expandable insert 200. Hollow structure 100 is preferably formed with two panels such that expandable insert 200 may be installed to one of first and second panels 102, 104 such that the other panel may be fastened thereto to form an inner surface 106 that generally surrounds expandable insert 200.

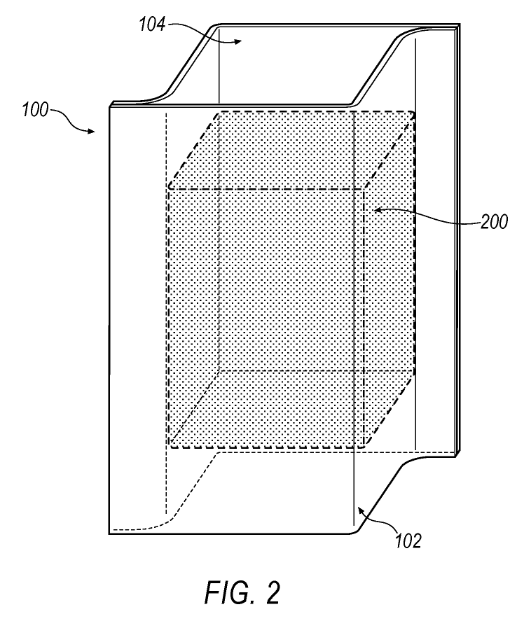

Expandable insert 200 may have a generally tubular shape that generally allows expandable insert 200 to conform to an overall shape of hollow structure 100. For example, as shown in FIGS. 1 and 2, expandable insert 200 may include an expandable body portion 202 having a continuous outer periphery 204 that abuts an inner surface 106 of hollow structure 100. Expandable insert 200 preferably defines a friction fit with inner surface 106 thereby retaining expandable insert 200 within hollow structure 100. For example, a diameter of expandable body 202 may be slightly larger than that of hollow structure 100, such that outer periphery 204 defines an interference fit with inner surface 106. Accordingly, expandable body 202 may be generally retained within hollow structure 100 by the interference or friction fit between outer periphery 204 and inner surface 106.

Expandable insert 200 may be formed of one or more known expandable materials, such as any expandable foam material. For example, expandable insert 200 may be formed of a baffle material that generally seals an intended cavity area of hollow structure 100, and may absorb vibration or sound transmitted through hollow structure 100 upon expansion. Known examples of baffle materials are available from Sika Corporation under the mark SikaBaffle®. Examples include commercially-available SikaBaffle® 240, SikaBaffle® 243, SikaBaffle® 250, SikaBaffle® 250 PB2, SikaBaffle® 250 PB3, SikaBaffle® 250NT, SikaBaffle® 255, and SikaBaffle® 229. Expandable insert 200 may be formed of a structural reinforcing material which generally improves structural qualities, e.g., rigidity, of hollow structure 100. Known examples of structural reinforcing materials are available from Sika Corporation under the mark SikaReinforcer®. Examples include commercially-available SikaReinforcer® 911, SikaReinforcer® 911PB, SikaReinforcer® 911NT, SikaReinforcer® 911NT/2, SikaReinforcer® 912, and SikaReinforcer® 913. Expandable insert 200 is preferably formed of a material that is non-tacky to allow easier handling of expandable insert 200 prior to installation. Further, expandable insert 200 is preferably formed of a material that is relatively flexible to allow easier installation of expandable insert 200 into hollow structure 100 or a component of hollow structure 100, e.g., first panel 102. Additionally, expandable insert 200 is preferably expandable by the application of heat, such as may be applied during a paint baking operation typical of automotive body assembly.

Expandable insert 200 preferably includes a generally consistent cross-sectional shape to allow expandable insert 200 to be produced using known thermoplastic forming processes such as injection molding, sheet extrusion, or profile extrusion, as examples. Expandable insert 200 is preferably extruded, thereby simplifying manufacturing of expandable insert 200. However, any cross-sectional shape may be employed, and any process may be employed that is convenient for forming expandable insert, as will be further illustrated below.

Expandable insert 200 may include a passageway 216 that extends between an upper end 206 and a lower end 210 of expandable body 202. Passageway 216 preferably allows cleaning washes, phosphates, electrocoating fluid, or any other fluid that may be applied to surfaces of hollow structure 100 to generally drain out of hollow structure 100. Passageway 216 generally allows fluid communication through passageway 216, for example between upper end 206 and lower end 210, and extends through outer periphery 204. Accordingly, passageway 216 is generally spaced away from outer periphery 204. Each of upper end 206 and lower end 210 may define an upper aperture or orifice 208 and lower aperture or orifice 212, respectively, disposed at either end of passageway 216. Passageway 216 may include an inner surface 214 of expandable body 202. Accordingly, inner surface 214 may cooperate with upper orifice 208 and lower orifice 212 to define passageway 216.

Turning now to FIG. 2, expanded insert 200′ is shown after expansion. Expansion of expandable insert 200 generally fills the entire cross-section of hollow structure 100, closing passageway 216. Fluid communication between upper end 206 and lower end 210 may be thus restricted or even prevented entirely. Accordingly, expandable insert 200 generally allows drainage of any fluids applied to hollow structure 100 prior to expansion of expandable insert 200 through passageway 216, while expanded insert 200′ generally prevents fluid communication between upper end 206 and lower end 210, effectively attenuating noise or vibrations transmitted through hollow structure 100, or preventing intrusion of external contaminants, e.g., vapor, moisture, water, etc.

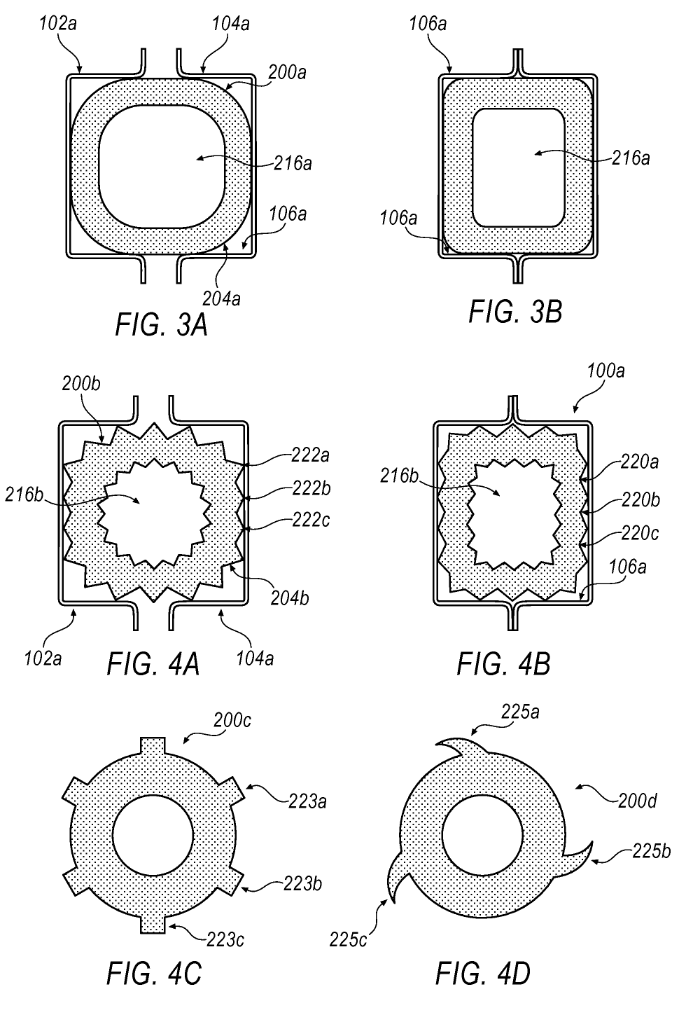

Turning now to FIGS. 3 through 5, a variety of cross sections for expandable insert 200 are shown. For example, as generally described above in regard to FIG. 1, an expandable insert 200a may have a generally circular cross section including a generally circular passageway 216a and a generally circular outer periphery 204a, as shown in FIGS. 3A and 3B. A circular cross section may generally provide for an effective retention of expandable insert 200a within hollow structure 100. As shown in FIG. 3A, expandable insert 200a may be installed into first panel 102a, and then second panel 104a may be joined, e.g., welded, to first panel 102a thereby enclosing hollow structure 100 around expandable insert 200a. The generally circular cross section shown in FIGS. 3A and 3B generally provides for a greater engagement between outer periphery 204 of expandable insert 200a and inner surface 106a of hollow structure 100a, thereby promoting greater retention between hollow structure 100a and expandable insert 200a.

Expandable insert 200b is shown in FIGS. 4A and 4B having a generally star shaped cross section, including a plurality of star points or engagement features 222a, b, c, etc. (collectively, 222). Engagement features 222 may generally abut or frictionally engage inner surfaces of the cavity, thereby holding expandable insert 200b in place, while providing a minimal footprint on the inner surfaces to allow any corrosion treatments applied to the inner surfaces to treat as much of a targeted area of the inner surfaces as possible. Expandable insert 200b may be installed within first panel 102a and second panel 104a in much the same way as described above for expandable insert 200a. However, upon installation of expandable insert 200b to hollow structure 100a, the generally star-shaped cross section of expandable insert 200b may provide additional drainage passages 220a, b, c, etc. (collectively, 220), about a perimeter of expandable insert 200b. These drainage passages are generally formed between each of the engagement features 222 or “star points” of expandable insert 200b along inner surface 106a of hollow structure 100a. Accordingly, any fluid, e.g., cleaning washes, phosphates, electrocoating or other liquids, applied to inner surface 106a of hollow structure 100a may drain not only through passageway 216b, but also around a perimeter of expandable insert 200b as defined by engagement features 222 and inner surface 106a.

Although engagement features 222 have been described above as being included in a generally star-shaped cross-section, other shapes and configurations for engagement features of expandable insert 200 are possible. For example, as shown in FIG. 4C, an expandable insert 200c may be provided with a plurality of square-shaped engagement features 223a, b, c, etc. (collectively, 223) for contacting surfaces of a hollow cavity (not shown in FIGS. 4C and 4D). Alternatively, as shown in FIG. 4D, an expandable insert 200d may be provided with three hook-shaped engagement features 225a, b, c, (collectively, 225). Accordingly, any number, shape, or configuration of engagement features of expandable insert 200 are possible. Engagement features preferably provide sufficient strength for retaining expandable insert 200 within a hollow structure, while also providing sufficient flexibility for easy installation into the hollow structure despite any interference fits between the expandable insert 200 and the hollow structure.

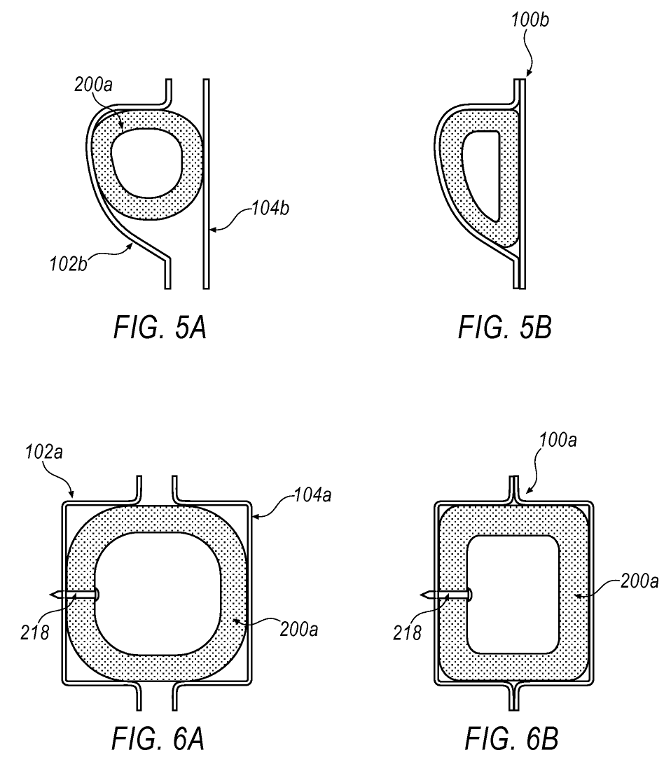

Although expandable insert 200 has been described specifically herein as having a circular or star-shaped cross-section, other cross-sections not specifically described herein are possible. Merely by way of example, expandable insert 200 may have any round, square, rectangular, or irregular cross-section that may be convenient. Additionally, other shapes of hollow structure 100 not specifically described above may be used in conjunction with expandable insert 200. Merely by way of example, and as shown in FIGS. 5A and 5B, a generally circular expandable insert 200a is shown with a hollow structure 100b that includes a first panel 102b defining a generally sloped shape, and a second panel 104b that is generally flat. The generally circular cross section and relatively flexible material composition of expandable insert 200a generally allows expandable insert 200a to conform to any cross section of hollow structure 100. However, expandable insert 200a may have any cross-sectional shape that is convenient.

As briefly described above, expandable insert 200 is preferably formed of a relatively flexible material that generally conforms to an overall shape of a hollow structure 100, thereby retaining expandable insert 200 securely within hollow structure 100 without additional fasteners or adhesives. Further, expandable insert 200 is preferably non-tacky to allow for handling prior to installation and expansion of expandable insert 200. However, any known adhesives or mechanical fasteners may be employed with expandable insert 200 if additional retention is desired. For example, as shown in FIGS. 6A and 6B, expandable insert 200a may have an installation pin 218 that generally secures expandable insert 200a to first panel 102a. Installation pin 218 may include any known fastener, such as a screw, nail, pin, etc.

As briefly described above, expandable insert 200 may be formed of multiple materials. A variety of examples are possible for materials having varying expansion ratios to control behavior of expandable insert 200 during expansion, and characteristics of expanded insert 200′. For example, expandable insert 200 may be provided with an outer surface formed of a first material having a predetermined expansion ratio, e.g., a structural reinforcing material, and an inner portion formed of a second material having a higher expansion ratio than the first material, e.g., a baffle material. Accordingly, upon application of heat, the second material would expand at a greater rate than the first material, thereby “forcing” the structural reinforcing material against inner surfaces of hollow structure 100. Any variety of known processes may be employed to form the materials including, but not limited to, sheet extrusion, profile extrusion, calendar extrusion, co-extrusion, thermoforming, vacuum forming, etc.

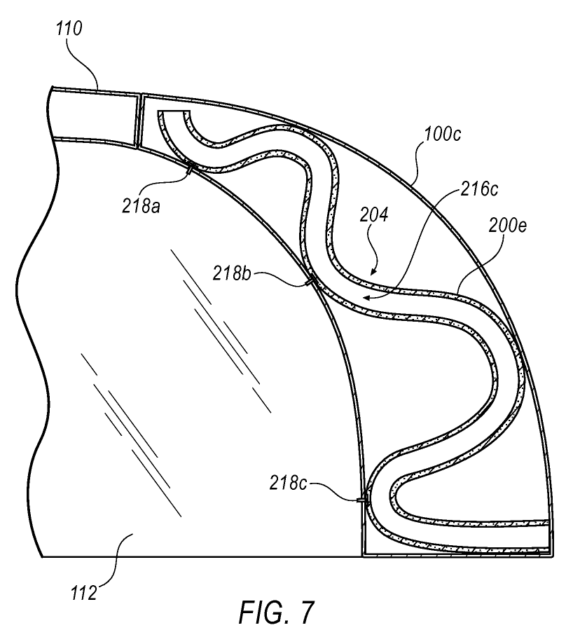

Turning now to FIG. 7, an expandable insert 200e is shown installed an irregularly shaped body cavity 100c, such as for a pillar structure of a vehicle (not shown). Cavity 100c may be any irregularly shaped cavity or hollow structure having a varying cross-section. For example, as shown in FIG. 7, cavity 100c may be a pillar structure of a motor vehicle, e.g., a “D-pillar,” that forms part of an upper greenhouse structure of the vehicle. As shown in FIG. 7, cavity 100c may be a D-pillar that defines an interface between a vehicle roof panel 110, a vehicle rear side window 112, and a rear window glass panel (not shown). Conveniently, expandable insert 200e may be relatively long, such that it may be bent, folded, or otherwise manipulated into body cavity 100c. Expandable insert 200e may be retained within body cavity 100c through a friction fit resulting from the folding or articulation of expandable insert 200e within cavity 100c, or nay be secured to surfaces of cavity 100c with one or more fasteners, e.g., fasteners 218a, 218b, and 218c as shown in FIG. 7, adhesives, etc. Similar to other versions of expandable insert 200 described above, expandable insert 200e includes a generally continuous outer periphery 204, with a passageway 216 extending therethrough to allow fluid communication. Accordingly, expandable insert 200e may be manipulated, folded, or bent to allow for retention within an irregularly shaped cavity, while providing beneficial drainage properties as described above. Expandable insert 200e is preferably formed of any expandable material described above, such that expandable insert 200e is operable to expand such that passageway 216 is closed, generally filling a cross-section of cavity 10c.

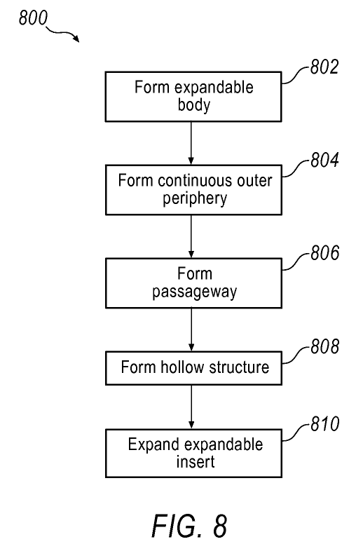

Turning now to FIG. 8, a process 800 for forming an expandable insert 200 is illustrated. Process 800 may generally begin at step 802, where expandable body 202 of expandable insert 200 is formed. For example, as described above, expandable body 202 may be formed of any of the baffle materials or structural reinforcing materials described above, or any other known expandable material. Expandable body 202 may be extruded, or formed in any other process that is convenient, e.g., any thermoplastic forming process. Process 800 may then proceed to step 804.

In step 804, a continuous outer periphery 204 may be formed about expandable body 202. For example, as described above, expandable insert 200 may be extruded, thereby generally forming expandable body 202 with a continuous outer periphery 204 in a single step. Process 800 may then proceed to step 806.

In step 806, a passageway 216 may be formed within expandable body 202 that extends through the continuous outer periphery 204. For example, as described above, expandable body 202 may be extruded, such that expandable body 202 is formed with an outer periphery 204 and a passageway 216 generally in a single step, thereby simplifying manufacture of expandable insert 200. More specifically, the extrusion process may force expandable material through an extrusion profile that forms an aperture in material forced through the extrusion profile. Alternatively, passageway 216 may be formed in expandable body 202 by any known material removal techniques, e.g., punching, drilling, boring, etc. Process 800 may then proceed to step 808.

In step 808, hollow structure 100 may be formed. For example, as described above, a first panel 102 may be provided into which expandable insert 200 is installed. As described above, expandable insert 200 may be installed with a fastener, such as installation pin 218. A second panel 104 may then be welded or otherwise fastened to first panel 102, thereby enclosing expandable insert 200 within hollow structure 100. Process 800 may then proceed to step 810.

In step 810, expandable insert 200 may be expanded to generally fill a cross-section of hollow structure 100. As described above, the expansion of expandable insert 200 may generally close passageway 216, thereby generally inhibiting or entirely preventing fluid communication between upper end 206 and lower end 210. Accordingly, intrusion of air, water, wind, and/or noise through expanded insert 200′, along any hollow structure, e.g., along a vehicle structure toward a vehicle passenger compartment (not shown) associated with the vehicle structure, may be attenuated. Expandable insert 200 may be formed of a material that expands by the application of heat, e.g., during a baking process used during a painting process of an automotive body. Process 800 may then terminate.

Accordingly, expandable insert 200 generally allows fluid communication through a hollow structure 100, e.g., drainage of any fluids such as cleaning washes, phosphates or electrocoating fluids applied to interior surface(s) of hollow structure 100. Further, expanded insert 200′ may generally fill at least a cross-section of hollow structure 100, thereby generally preventing fluid communication along the hollow structure 100. Finally, expandable insert 200 may be formed by any known thermoplastic forming processes, e.g., extrusion, thereby generally simplifying manufacture of expandable insert 200 and assembly of hollow structure 100.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain approaches, examples or embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. An expandable insert, comprising:
an expandable body extending along a hollow structure, said expandable body including:
a continuous outer periphery; and
a passageway extending through said outer periphery, said passageway allowing fluid communication therethrough;
wherein said expandable body is operable to expand such that said expandable body fills a cross-section of the hollow structure.

2. The expandable insert of claim 1, wherein said expandable body is operable to expand to close said passageway, generally preventing fluid communication through said passageway.

3. The expandable insert of claim 1, wherein said outer periphery defines a friction fit with an inner surface of the hollow structure to retain said expandable body within said hollow structure.

4. The expandable insert of claim 1, wherein said expandable body is operable to expand upon application of heat.

5. The expandable insert of claim 1, wherein said expandable body is formed of a baffle material operable to absorb vibrations transmitted through the hollow structure.

6. The expandable insert of claim 1, wherein said expandable body is formed of a structural reinforcing material operable to structurally reinforce the hollow structure.

7. The expandable insert of claim 1, wherein said expandable body is extruded.

8. The expandable insert of claim 1, wherein said expandable body defines a generally circular cross-section.

9. The expandable insert of claim 1, wherein said expandable body defines a cross section having a plurality of engagement features for abutting an inner surface of the hollow structure.

10. A method of forming an expandable insert, comprising:
forming an expandable body that extends along a hollow structure, including:
forming a continuous outer periphery;
forming a passageway that extends through said outer periphery, said passageway allowing fluid communication therethrough; and
expanding said expandable body to fill a cross-section of the hollow structure.

11. The method of claim 10, wherein expanding said expandable body closes said passageway to generally prevent fluid communication therethrough.

12. The method of claim 10, further comprising retaining said expandable body within the hollow structure by sizing said expandable body to define a friction fit with an inner surface of the hollow structure.

13. The method of claim 10, wherein expanding said expandable body includes applying heat to said expandable body.

14. The method of claim 10, wherein said expandable body is formed of an expandable foam material.

15. The method of claim 10, wherein said expandable body is formed of one of a baffle material and a structural reinforcing material.

16. The method of claim 10 wherein forming said expandable body includes extruding said expandable body.

17. A vehicle structure, comprising:
at least one panel, said at least one panel having an inner surface defining a hollow cavity; and
an expandable insert having a body portion, including:
a continuous outer periphery, said outer periphery encircled by said inner surface of said hollow cavity; and
a passageway extending through said outer periphery to allow fluid communication therethrough;
wherein said expandable insert is operable to expand to generally fill said hollow cavity.

18. The vehicle structure of claim 17, wherein said expandable insert is operable to expand to close said passageway, generally preventing fluid communication therethrough.

19. The vehicle structure of claim 17, wherein said expandable insert is operable to expand to close said passageway, generally preventing intrusion of one of air, moisture, vibration, and noise into a passenger compartment associated with the vehicle structure.

20. The vehicle structure of claim 17, wherein said expandable insert defines a friction fit with said inner surface of said at least one panel to retain said expandable insert within said hollow cavity.

21. The vehicle structure of claim 17, wherein said expandable insert is formed of an expandable foam material.

22. The vehicle structure of claim 17, wherein said expandable insert is formed of one of a baffle material and a structural reinforcing material.

23. The vehicle structure of claim 17, wherein said body portion is extruded.
